(19) United States
(12) Patent Application Publication
(10) Pub. No.: US 2026/0257344 A1
(43) Pub. Date: Sep. 3, 2026

(54) ROBOT POWER TRANSMISSION MECHANISM FOR TRANSMITTING ROTATIONAL FORCE AND ROBOT DRIVE UNIT

(71) Applicant: FANUC CORPORATION, Yamanashi (JP)

(72) Inventor: Kazutaka NAKAYAMA, Yamanashi (JP)

(21) Appl. No.: 18/873,333

(22) PCT Filed: Jul. 13, 2022
(86) PCT No.: PCT/JP2022/027583

§ 371 Date: Dec. 10, 2024

(51) Int. Cl. B25J 9/10; F16H 49/00

(52) U.S. Cl. CPC B25J 9/1025; F16H 49/001

(57) ABSTRACT

A robot power transmission mechanism according to the present invention is provided with a strain wave gearing reducer including: a wave generating member including an elliptical cam; an elastic cylindrical member having first teeth; and an annular member having second teeth that mesh with the first teeth. A shaft that transmits the rotational force of an electric motor has a spline shaft part having protrusions formed on the outer circumferential surface thereof. The wave generating member includes insertion holes having a recessed shape corresponding to the shape of the protrusions of the spline shaft part. Between the spline shaft part and the insertion holes, there is a gap having a size sufficient to allow the wave generating member to align through movement made possible by the elasticity of the elastic cylindrical member.

### RELATED APPLICATIONS

The present application is National Phase of International Application Number PCT/JP2022/027583, filed Jul. 13, 2022.

### TECHNICAL FIELD

The present invention relates to a robot power transmission mechanism for transmitting a rotational force and to a robot drive device.

### BACKGROUND ART

A robot can change the position and orientation of a work tool by driving a constituent member such as an arm. A drive device including an electric motor for moving the constituent member is arranged at the robot. For example, when the robot has a joint, the drive device for moving the constituent member is arranged at the joint. The drive device includes a power transmission mechanism for transmitting a rotational force from one member to another member.

It is known that a decelerator is arranged at the power transmission mechanism in order to amplify the rotational force of the electric motor. As the decelerator, in addition to a gear reducer having a structure in which many gears mesh with each other, a strain wave gear reducer including an elliptical member to which a rotational force is input is known (e.g., Japanese Unexamined Patent Publication No. 2021-175916 A). The strain wave gear reducer is characterized by a small number of components and a compact size. It is known that a strain wave gear reducer is used in a drive device for a robot (e.g., Japanese Unexamined Patent Publication No. 3-202292 A).

### CITATION LIST

### Patent Literature

PTL 1: Japanese Unexamined Patent Publication No. 2021-175916 A

PTL 2: Japanese Unexamined Patent Publication No. 3-202292 A

### SUMMARY OF INVENTION

### Technical Problem

The drive device transmits the rotational force of a shaft output from the electric motor to an input member of the decelerator. When the decelerator is a strain wave gear reducer, the rotational force of the shaft output from the electric motor is transmitted to a wave generator (wave generating member) as the input member. For example, a key groove is formed at the outer circumferential surface of an output shaft of the electric motor and the inner circumferential surface of an insertion hole of the input member of the decelerator. A key having a shape that fits in the key grooves is inserted. Further, the key can be fixed with a hexagon socket set screw or the like to form key coupling. By the key coupling, coupled members can be prevented from sliding in a circumferential direction.

However, with the key coupling, the key may be deteriorated due to long-term use. As a result, there is a possibility that the rotational force cannot be reliably transmitted. In other words, there is a problem in that the reliability of maintaining the function of transmitting the rotational force is low. Further, in the key coupling, the hexagon socket set screw or the like is inserted in one radial direction. As a result, a deviation may occur between the rotation axis of the input member of the decelerator and the rotation axis of the output shaft of the electric motor. Then, vibration may occur when the drive device is driven. In order to prevent the occurrence of vibration, it is necessary to perform alignment of the input member of the decelerator or the output shaft such that the rotation axis of the input member of the decelerator coincides with the rotation axis of the output shaft of the electric motor.

Alternatively, it is possible to arrange an Oldham's coupling between the output shaft of the electric motor and the input member of the decelerator in order to omit the adjustment of the positions of the rotation axes. By arranging an Oldham's coupling, even when there is a deviation between the rotation axes, the rotational force can be transmitted while reliably performing the alignment, and the occurrence of vibration can be prevented. However, employment of an Oldham's coupling causes a problem in that the number of components increases and the drive device becomes expensive. Further, since space is required in order to arrange an Oldham's coupling, a problem arises in that the size of the drive device becomes large in the axial direction.

A power transmission mechanism for a robot of an aspect of the present disclosure includes a shaft that transmits a rotational force of an electric motor, and a strain wave gear reducer that amplifies the rotational force of the electric motor. The strain wave gear reducer includes a wave generating member including a cam having an elliptical shape when viewed from a direction of a rotation axis, an elastic tubular member including a plurality of first tooth parts at an outer circumferential surface and being elastically deformable, and an annular member including a plurality of second tooth parts at an inner circumferential surface. Part of the first tooth parts of the elastic tubular member and part of the second tooth parts of the annular member are engaged with each other. The shaft includes a spline shaft part including a plurality of protrusions formed in a circumferential direction of an outer circumferential surface. The wave generating member includes an insertion hole into which the spline shaft part is inserted and that has recesses having a shape corresponding to a shape of the protrusions of the spline shaft part. The spline shaft part and the insertion hole have a shape in which a gap in a radial direction is present between the spline shaft part and the insertion hole. The gap has a size such that the rotation center axis of the wave generating member is always movable and alignment is possible due to the elasticity of the elastic tubular member in a direction in which the eccentricity with respect to the center axis of the elastic tubular member is canceled.

A drive device for a robot according to an aspect of the present disclosure includes the power transmission mechanism described above and an electric motor that rotates a shaft.

### Advantageous Effects of Invention

According to the aspects of the present disclosure, it is possible to provide a power transmission mechanism for a robot and a drive device for a robot that suppress vibration.

### BRIEF DESCRIPTION OF DRAWINGS

FIG. 1 is a perspective view of a robot in an embodiment.

FIG. 2 is a schematic cross-sectional view of a drive device including a power transmission mechanism in the embodiment.

FIG. 3 is an enlarged schematic cross-sectional view of the power transmission mechanism.

FIG. 4 is a schematic partial cross-sectional view of a decelerator in the embodiment.

FIG. 5 is an enlarged schematic cross-sectional view of a portion at which a shaft and a wave generating member are engaged with each other in the embodiment.

FIG. 6 is an enlarged schematic cross-sectional view of a power transmission mechanism in a comparative example.

### DESCRIPTION OF EMBODIMENTS

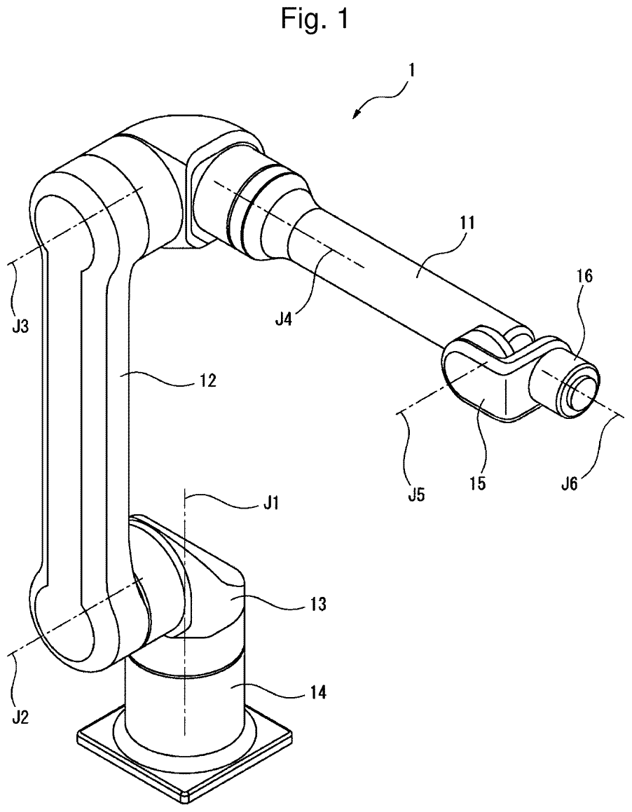

A power transmission mechanism for a robot and a drive device provided with the power transmission mechanism for a robot according to an embodiment will be described with reference to FIG. 1 to FIG. 6. The power transmission mechanism of the present embodiment transmits the rotational force of an electric motor from one member to another member. The drive device of the present embodiment rotates one constituent member of a robot relative to another constituent member.

FIG. 1 is a perspective view of a robot in the present embodiment. A robot 1 of the present embodiment is an articulated robot including a plurality of joints. The robot 1 includes a plurality of constituent members that are rotatable. The respective constituent members are formed so as to rotate about drive axes J1 to J6. The drive device of the present embodiment is arranged at a joint of a robot in order to drive a constituent member of the robot.

The robot 1 includes a base 14 fixed at an installation surface and a swivel base 13 supported by the base 14. The swivel base 13 rotates about a drive axis J1 with respect to the base 14. The robot 1 includes a front arm 11 and an upper arm 12. The upper arm 12 rotates about a drive axis J2 with respect to the swivel base 13. The front arm 11 rotates about a drive axis J3 with respect to the upper arm 12. Further, the front arm 11 rotates about a drive axis J4. The robot 1 includes a wrist 15 supported by the front arm 11. The wrist 15 rotates about a drive axis J5. In addition, the wrist 15 includes a flange 16 that rotates about a drive axis J6. A work tool is fixed at the flange 16 in accordance with a work carried out by a robot apparatus provided with the robot 1.

The robot 1 of the present embodiment includes, as constituent members, the base 14, the swivel base 13, the upper arm 12, the front arm 11, and the wrist 15. The robot of the present embodiment has six drive axes, but is not limited to this configuration. A robot that changes the position and orientation by any mechanism can be employed.

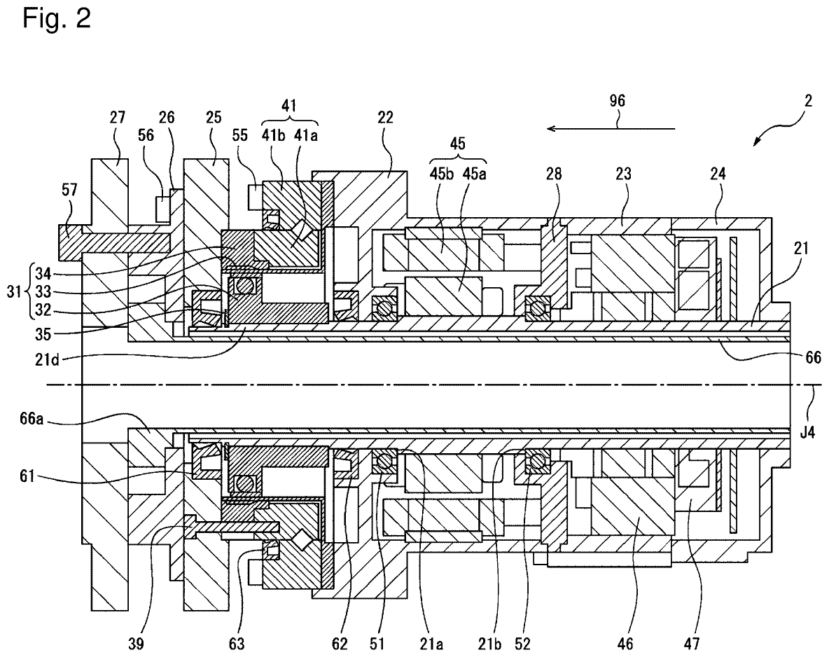

FIG. 2 illustrates a cross-sectional view of the drive device in the present embodiment. In the present embodiment, as an example, a drive device 2 for rotating the front arm 11 about the drive axis J4 will be described with reference to FIG. 1 and FIG. 2. The drive device 2 is arranged at an end portion of the front arm 11 opposite to a side at which the wrist 15 is arranged. For example, the drive device 2 is arranged such that a direction indicated by an arrow 96 coincides with a direction in which the wrist 15 is arranged.

The drive device 2 is provided with an electric motor 45 including a rotor 45a and a stator 45b. The rotor 45a is fixed at a shaft 21. The shaft 21 functions as an output shaft of the electric motor 45. The shaft 21 is formed to extend in an elongated shape. The shaft 21 of the present embodiment has a hollow hole. In other words, the shaft 21 of the present embodiment is a hollow shaft having a cylindrical shape. The shaft 21 rotates about the drive axis J4 as a rotation axis.

The rotational force of the shaft 21 is transmitted to a flange 25 via a decelerator 31. The flange 25 and a flange 26 are fixed to each other with a bolt 56. The flange 26 and a flange 27 are fixed to each other with a bolt 57. The flanges 25, 26, 27 rotate integrally. The flange 27 is fixed at, for example, a housing that rotates about the drive axis J4 of the front arm 11.

The drive device 2 includes a housing 22 in which the electric motor 45 is arranged. The shaft 21 that transmits the rotational force of the electric motor 45 is rotatably supported by bearings 51, 52. The bearing 51 is fixed at the housing 22. The drive device 2 includes a housing 23 in which an electromagnetic brake 46 is arranged and a housing 24 in which an encoder 47 serving as a rotational position detector is arranged. The electromagnetic brake 46 brakes the shaft 21. The encoder 47 detects a rotational position of the electric motor 45.

The housing 22 of the present embodiment is fixed at a housing that does not rotate about the drive axis J4 among the housings of the front arm 11. The housing 22, the housing 23, and the housing 24 are fixed to each other with fastening members such as bolts. A bearing fixing member 28 for fixing the bearing 52 is arranged between the housing 22 and the housing 23. The bearing fixing member 28 is fixed at the housing 23 with a fastening member such as a bolt. By removing the fastening members, the housings 24, 23, 22 and the bearing fixing member 28 can be removed from the side opposite to the direction indicated by the arrow 96.

A protective tube 66 made of resin is arranged inside the shaft 21. The protective tube 66 is formed in a cylindrical shape along the inner surface of the shaft 21. A wire body such as an electric wire, an air tube, or an optical communication cable is inserted into the protective tube 66. The protective tube 66 is fixed by a sandwiched part 66a being sandwiched between the flange 26 and the flange 27. By arranging the protective tube 66, the wire body can be arranged inside a joint of the robot 1.

The shaft 21 of the present embodiment includes a step part 21a and a step part 21b for restricting the movement of the shaft 21 in a direction in which the rotation axis extends. The bearings 51, 52 are engaged with the step part 21a and the step part 21b. The bearing 51 is fixed by the housing 22, and the bearing 52 is fixed by the bearing fixing member 28.

Oil seals 61, 62 are arranged at the outer circumferential surface of the shaft 21 so as to prevent internal lubricating oil from leaking to the outside and to prevent a foreign matter from entering from the outside. In addition, an oil seal 63 is arranged so as to prevent lubricating oil inside a main bearing 41 from leaking to the outside and to prevent a foreign matter from entering from the outside.

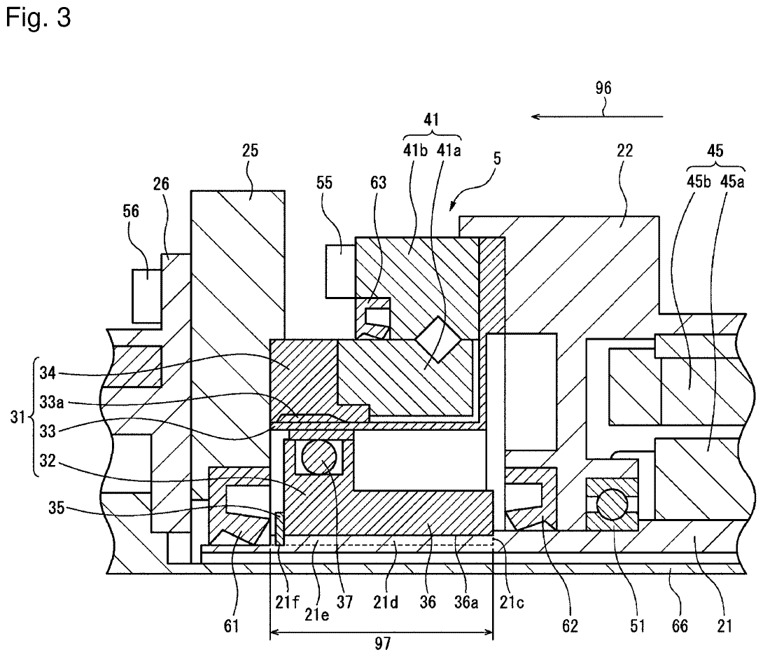

FIG. 3 illustrates an enlarged cross-sectional view of the power transmission mechanism of the drive device in the present embodiment. Referring to FIG. 2 and FIG. 3, the drive device 2 includes a power transmission mechanism 5 that transmits the rotational force output by the electric motor 45 to the flanges 25, 26, 27. The power transmission mechanism 5 includes the shaft 21 and the decelerator 31 that amplifies the rotational force of the shaft 21.

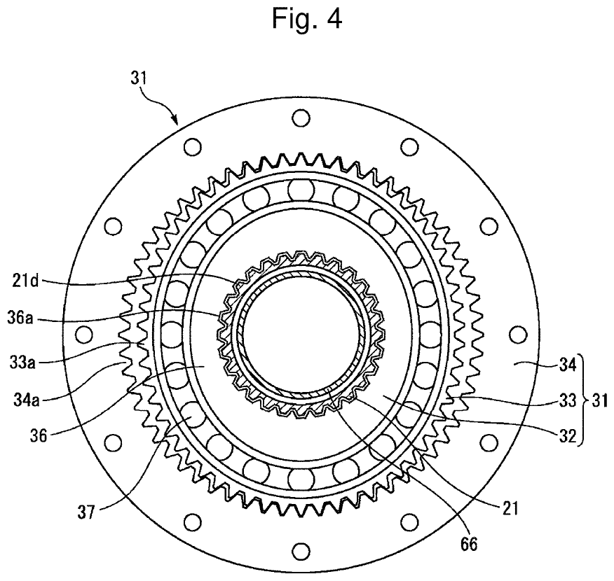

FIG. 4 illustrates a schematic partial cross-sectional view of the decelerator of the present embodiment. FIG. 4 is a partial cross-sectional view when the decelerator 31 is viewed in a direction opposite to the arrow 96 out of the directions of the rotation axis. Referring to FIG. 2 to FIG. 4, the decelerator 31 of the present embodiment is a strain wave gear reducer. The decelerator 31 includes a wave generating member 32 as an input part to which the rotational force is input. The wave generating member 32 is referred to as a wave generator. The wave generating member 32 includes a hub 36 having an elliptical shape (planar shape) when viewed from the direction of the rotation axis, and a ball bearing 37 arranged at the outer circumferential surface of the hub 36. The hub 36 serves as a cam having an elliptical planar shape. In particular, the hub 36 of the wave generating member 32 serves as an input part of the decelerator 31. The inner race of the ball bearing 37 is fixed at the hub 36 having an elliptical shape. The outer race of the ball bearing 37 is formed so as to be elastically deformable in response to the rotation of the hub 36 via balls.

The decelerator 31 includes an elastic tubular member 33 that is elastically deformable. The elastic tubular member 33 is an external gear and is referred to as a flex spline. The elastic tubular member 33 is arranged outside the wave generating member 32. The elastic tubular member 33 includes a plurality of first tooth parts 33a formed at the outer circumferential surface. The elastic tubular member 33 is formed so as to be deformed in response to the rotation of the hub 36. The elastic tubular member 33 of the present embodiment is fixed at the housing 22 with a bolt 55. While the wave generating member 32 rotates, the elastic tubular member 33 is fixed so as not to rotate.

The decelerator 31 includes an annular member 34. The annular member 34 is an internal gear and referred to as a circular spline. The annular member 34 has rigidity so as not to be easily deformed. The annular member 34 is arranged outside the elastic tubular member 33. A plurality of second tooth parts 34a are formed at the inner circumferential surface of the annular member 34. Since the hub 36 has an elliptical shape, the first tooth parts 33a and the second tooth parts 34a engage with each other in the direction of the major axis of the ellipse. In other words, part of the first tooth parts 33a of the elastic tubular member 33 and part of the second tooth parts 34a of the annular member 34 are engaged with each other.

In this regard, the number of teeth of the first tooth parts 33a of the elastic tubular member 33 is smaller than the number of teeth of the second tooth parts 34a of the annular member 34. For example, the number of teeth is different by two. When the wave generating member 32 makes one rotation, the annular member 34 rotates slightly in accordance with the difference in the number of teeth between the tooth parts 33a and 34a. In the present embodiment, the annular member 34 serves as an output part of the decelerator 31. The decelerator 31 can reduce the speed at a reduction ratio depending on the number of teeth of the elastic tubular member 33 and the number of teeth of the annular member 34.

The rotational force at the time at which the speed is reduced is output from the annular member 34. The main bearing 41 is arranged at a side of the annular member 34. The main bearing 41 of the present embodiment is a cross-roller bearing. The main bearing 41 includes an inner race 41a and an outer race 41b. The outer race 41b is fixed at the housing 22 together with the elastic tubular member 33 with the bolt 55. The outer race 41b is a member that does not rotate with respect to the housing 22. On the other hand, the inner race 41a is fixed at the flange 25 and the annular member 34 with a bolt 39. Thus, the inner race 41a, the annular member 34, the flanges 25, 26, 27, and the protective tube 66 rotate integrally. The rotational force of the annular member 34 is transmitted via the flanges 25, 26, 27 to the housing that rotates about the drive axis J4 of the front arm 11.

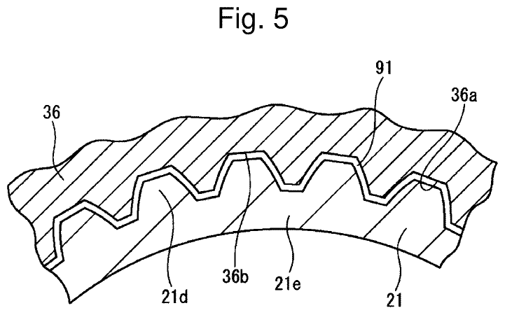

FIG. 5 illustrates an enlarged cross-sectional view of a part at which the shaft engages with the hub of the wave generating member. Referring to FIG. 3 to FIG. 5, the power transmission mechanism 5 transmits the rotational force of the shaft 21 to the hub 36 of the wave generating member 32, the hub 36 serving as the input part of the decelerator 31. In the present embodiment, the rotational force of the shaft 21 is transmitted to the hub 36 by spline coupling.

The shaft 21 includes a spline shaft part 21e at which a plurality of protrusions 21d are formed at predetermined intervals in the circumferential direction of the outer circumferential surface. The spline shaft part 21e is a part extending along the axial direction. The spline shaft part 21e is formed in a region indicated by the arrow 97. The spline shaft part 21e is formed in a region facing the hub 36. The protrusions 21d are formed so as to project outward. The protrusions 21d extend along the axial direction. The protrusions 21d and recesses which correspond to tooth parts of a gear are formed in the circumferential direction.

The hub 36 of the wave generating member 32 includes an insertion hole 36b into which the spline shaft part 21e is inserted. In the present embodiment, the insertion hole 36b penetrates through from one end face to the other end face of the hub 36 in the axial direction. The insertion hole 36b has a shape corresponding to the shape of the spline shaft part 21e. Recesses 36a are formed at the inner circumferential surface of the insertion hole 36b. The recesses 36a extend along the axial direction.

The protrusions 21d at the outer circumferential surface of the spline shaft part 21e and the recesses 36a at the inner circumferential surface of the insertion hole 36b are formed along perfect circles in cross-sectional shapes thereof. In this way, the plurality of tooth parts are formed at the outer circumferential surface of the shaft 21, and the plurality of tooth parts that engage with the tooth parts of the shaft 21 are formed at the inner circumferential surface of the hub 36. An engagement part of spline coupling is formed in a region at which the plurality of tooth parts face each other. By employing spline coupling, the rotational force can be reliably transmitted.

The power transmission mechanism 5 of the present embodiment includes a movement restriction part that restricts the movement of the wave generating member 32 in the axial direction (the direction of the rotation axis). Since a load in a thrust direction acts on the wave generating member 32 due to the elasticity of the elastic tubular member 33, it is necessary to restrict the movement. The movement restriction part of the present embodiment restricts the movement of the wave generating member 32 in two axial directions. The movement restriction part in the present embodiment includes a C-ring 35 as a retaining ring arranged so as to be in contact with an end face of the hub 36 in the axial direction. The C-ring 35 has a shape that restricts the movement of the wave generating member 32 in the axial direction. The C-ring 35 limits the movement of the hub 36 in the direction indicated by the arrow 96.

A recess 21f corresponding to the shape of the C-ring 35 is formed at the spline shaft part 21e of the shaft 21. The C-ring 35 is fitted into the recess 21f extending in the circumferential direction. By employing the C-ring as the movement restriction part, it is possible to restrict the movement of the wave generating member 32 in the axial direction with a simple structure. Further, the C-ring 35 can be easily removed. Thus, the power transmission mechanism can be easily disassembled to remove the decelerator 31. The retaining ring is not limited to the C-ring, and a member having any ring shape can be employed. For example, an E-ring can be employed as the retaining ring. A structure other than the ring may be used as long as the movement can be restricted.

Further, the movement restriction part of the present embodiment includes a step part 21c which is formed at the shaft 21 and at which the outer diameter of the shaft 21 is changed. The step part 21c can be formed in a region of the spline shaft part 21e in which the protrusions 21d are formed. In other words, the step part 21c can be formed such that the height of the protrusions 21d is increased. The step part 21c is formed so as to be in contact with an end face of the wave generating member 32 in the axial direction. The step part 21c has a shape that limits the movement of the wave generating member 32 in the axial direction. The step part 21c limits the movement of the wave generating member 32 in a direction opposite to the direction indicated by the arrow 96. By configuring the movement restriction part with the step part, it is possible to limits the movement of the wave generating member in the axial direction without using another member for limiting the movement.

The step part is not limited to this configuration, and may be formed at a terminal end part of the spline shaft part 21e. In other words, the step part may be formed at a boundary between the region in which the protrusions are formed and the region in which the protrusions are not formed. In addition, any member that restricts the movement of the wave generating member in the axial direction can be employed as the movement restriction part. For example, the wave generating member may be fixed at the shaft with a bolt or adhesive. Alternatively, the step part may be replaced with a C-ring.

Referring to FIG. 5, the spline shaft part 21e and the insertion hole 36b have shapes in which a gap 91 which is a thin space is present between the spline shaft part 21e and the insertion hole 36b. In particular, the gap 91 is formed in the radial direction in a cross-sectional shape cut along a plane perpendicular to the axial direction. In other words, the insertion hole 36b has recesses 36a having a shape corresponding to the shape of the protrusions 21d of the spline shaft part 21e, and is formed so as to be slightly larger than the width of the teeth of the spline shaft part 21e in the circumferential direction.

The shaft 21 is supported by the bearings 51, 52 fixed at the housing 22. The rotation axis of the shaft 21 is defined by the positions of bearings 51, 52. On the other hand, the outer race of the ball bearing 37 is in contact with the inner circumferential surface of the elastic tubular member 33. In the direction of the major axis of the ellipse shape of the hub 36, the tooth parts 33a of the elastic tubular member 33 are in contact with the tooth parts 34a of the annular member 34. In this case, the wave generating member 32 is assembled so as to be squeezed into the elastic tubular member 33, and the elastic tubular member 33 is elastically deformed so as to be expanded. A force of the elastic tubular member 33 for returning to the original shape produces a function of automatically aligning the rotation axis of the wave generating member 32 to the rotation axis of the elastic tubular member 33.

The shape of the elastic tubular member 33 when viewed from the direction of the rotation axis is an ellipse. A force of returning to a perfect circle when viewed from the direction of the rotation axis acts on the elastic tubular member 33. The hub 36 is supported only by the elastic tubular member 33 in the radial direction, and is in a state of floating in the air with respect to the shaft 21. A torque is distributed and transmitted by the plurality of teeth of the spline in a state in which the rotation center axis of the wave generating member 32 is always aligned. In other words, the rotation center axis is aligned at all rotational positions of the wave generating member 32. At this time, although a thrust force acts in the axial direction of the wave generating member 32, the wave generating member 32 does not move in the axial direction due to the function of the movement restriction part described above.

In such a situation, the position of the rotation axis of the hub 36 of the wave generating member 32 and the position of the rotation axis of the shaft 21 may slightly differ from each other due to a processing error or the like. In the present embodiment, the gap 91 is formed between the inner circumferential surface of the insertion hole 36b of the hub 36 and the outer circumferential surface of the spline shaft part 21e of the shaft 21. Thus, the gap 91 can absorb the above-described error between the positions of the rotation axes.

The gap 91 has a size such that the rotation center axis of the wave generating member 32 is always movable and alignment is possible due to the elasticity of the elastic tubular member 33 in a direction in which the eccentricity with respect to the center of the elastic tubular member 33 is canceled. More specifically, the gap 91 is preferably formed to be large so as not to impair the function of aligning the wave generating member 32. When the gap 91 is too small, the wave generating member 32 cannot be sufficiently moved by the elastic force of the elastic tubular member 33, and alignment is insufficient, which may cause vibration.

On the other hand, when a component in the rotation direction of the gap 91 between the spline shaft part 21e and the insertion hole 36b of the hub 36 is large, an angle transmission error reflected in the output part of the decelerator 31 become large. The angle transmission error corresponds to a value obtained by dividing the magnitude of the component of the gap 91 in the rotation direction by a reduction ratio of the decelerator 31. As described above, the gap 91 is preferably kept small to such a level that the gap 91 does not substantially adversely affect the function of the decelerator, in other words, the operation of the robot.

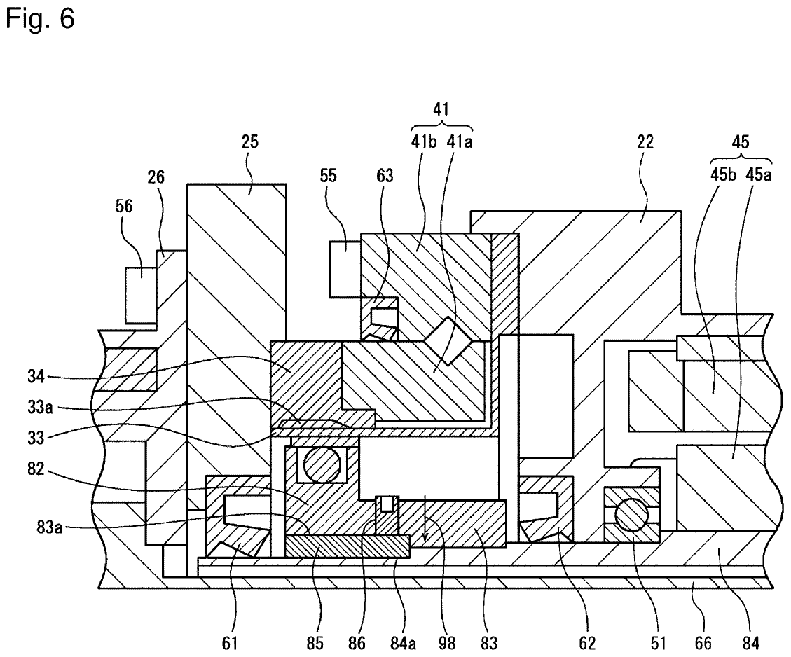

FIG. 6 illustrates an enlarged schematic cross-sectional view of a power transmission mechanism of a comparative example. The power transmission mechanism of the comparative example includes a shaft 84 to which the rotational force of an electric motor is transmitted. In the power transmission mechanism of the comparative example, the rotational force of the shaft 84 is transmitted to a hub 83 of a wave generating member 82 by key coupling. A key groove 84a is formed at the shaft 84. A key groove 83a is formed at the hub 83. A key 85 having a rectangular parallelepiped shape is inserted into a region of the key grooves 83a, 84a facing each other.

A set screw (hexagon socket set screw) 86 is inserted into the hub 36. The key 85 is fixed with the set screw 86. The set screw 86 is inserted inward in the radial direction as indicated by an arrow 98. Thus, the shaft 84 is pressed in a direction indicated by the arrow 98. On the other hand, a force opposite to the direction indicated by the arrow 98 acts on the wave generating member 82 due to a reaction force of the axial force of the set screw 86. The wave generating member 82 may be arranged so as to rotate about a rotation axis deviated from the unique rotation axis of the decelerator 31 due to an influence of a fitting gap between the shaft 84 and the hub 83. In that case, vibration may occur when the decelerator is driven. Alternatively, an Oldham's coupling may be arranged between the shaft 84 and the wave generating member 82 in order to suppress vibration caused by a positional deviation of the rotation axis. An Oldham's coupling has a configuration in which a radially-movable insert is arranged between one member and the other member. For example, the one member of the Oldham's coupling may be fixed at the shaft 84 and the other member may be fixed at the wave generating member 82. The decelerator can be smoothly driven while maintaining a state in which the position of the rotation axis of the shaft 84 and the position of the rotation axis of the wave generating member 82 are deviated from each other.

However, when an Oldham's coupling is arranged, the length of the power transmission mechanism in the axial direction becomes large, and the power transmission mechanism becomes large. Further, in the power transmission mechanism of the comparative example, key coupling is employed as a coupling method for reliably transmitting the rotational force. In the key coupling, when the key is used for a long period of time, the key may be unevenly worn due to an increase in surface pressure caused by partial contact, and thus reliability is low.

Referring to FIG. 3 to FIG. 5, on the other hand, in the power transmission mechanism in the present embodiment, the wave generating member 32 can be aligned by the elastic force of the elastic tubular member 33. The wave generating member 32 can rotate about a rotation axis at an optimum position. In addition, when the position of the rotation axis of the wave generating member 32 and the position of the rotation axis of the shaft 21 are slightly different from each other, the gap 91 between the inner circumferential surface of the wave generating member 32 and the outer circumferential surface of the shaft 21 can absorb the difference between the positions of the rotation axes. As a result, the decelerator 31 can be smoothly driven while suppressing vibration of the decelerator 31. In the power transmission mechanism of the present embodiment, since other components such as an Oldham's coupling are not used, the number of components can be kept small.

Further, in the power transmission mechanism of the present embodiment, since neither a key groove nor a key is used, even when the power transmission mechanism is continuously used for a long period of time, breakage or the like of a key does not occur, and the reliability of the decelerator can be maintained for a long period of time.

The shaft 21 in the present embodiment is a cylindrical member having a hollow hole. Since the hollow shaft has a thin wall thickness, it is difficult to form a deep key groove (an area for transmitting torque) by which a sufficient torque can be transmitted. In the present embodiment, by forming the protrusions of the spline shaft to be small and providing a large number of teeth, it is possible to form a structure that reliably transmits a rotational force even with the hollow shaft. As described above, even when the shaft for outputting the rotational force of the electric motor is a hollow shaft, it is possible to provide a power transmission mechanism that reliably transmits the rotational force while ensuring long-term reliability.

Referring to FIG. 5, preferably, the protrusions 21d of the shaft 21 and the recesses 36a of hub 36 each have a cross-sectional shape formed by an involute curve. In other words, the rotational force is preferably transmitted by involute spline. By employing this configuration, the strengths of the teeth of the spline shaft and the insertion hole can be increased. Resistance to axial sliding and radial swing is increased. In addition, a torque can be equally distributed to the respective protrusions. Further, the involute spline has a feature of being aligned when the torque is transmitted. However, in order to prevent wear due to poor lubrication, it is desirable to apply, to the meshing part of the teeth of the spline, a sufficient amount of the same lubricating oil as the lubricating oil applied to the meshing part of the teeth of the decelerator at the time of assembly. The spline is not limited to the involute spline, and any spline having protrusions of an arbitrary shape can be employed. For example, a rectangular spline in which a cross-sectional shape of a protrusion is substantially quadrangular can be employed.

Referring to FIG. 2 and FIG. 3, the drive device 2 of the present embodiment can be disassembled so that the decelerator 31 is removed and replaced. In disassembling the drive device 2, the flange 27 can be removed from the flange 26 by removing the bolt 57. Further, the fixing of the protective tube 66 is released, and the protective tube 66 can be pulled out in the direction indicated by the arrow 96. Subsequently, the flange 26 can be removed from the flange 25 by removing the bolt 56. Then, the flange 25 can be removed by removing the bolt 39.

Next, the decelerator 31 and the main bearing 41 can be removed by removing the C-ring 35 and the bolt 55. In this way, the decelerator 31 can be replaced by disassembling the drive device 2. Further, the bearings 51, 52, the oil seals 61, 62, 63 and the like can also be replaced. In assembly, the drive device 2 can be assembled in a reverse procedure to disassembling. The drive device 2 in the present embodiment can be easily disassembled by removing fastening members, and thus components can be replaced.

In the above-described embodiment, the power transmission mechanism that drives the constituent members about the drive axis J4 of the robot 1 and the drive device of the robot have been described, but the embodiment is not limited to this. The power transmission mechanism and the drive device in the present embodiment can be applied to a power transmission mechanism that transmits a rotational force of an arbitrary member of a robot and a drive device that drives an arbitrary constituent member of the robot.

The above-described embodiments can be combined as appropriate. In each of the above-described drawings, the same or equivalent parts are denoted by the same reference signs. The above-described embodiments are merely examples and do not limit the invention. In addition, the embodiments include the modifications of the embodiments defined in the claims.

1. A power transmission mechanism for a robot, comprising:
a shaft configured to transmit a rotational force of an electric motor; and
a strain wave gear reducer configured to amplify the rotational force of the electric motor, wherein
the strain wave gear reducer includes a wave generating member including a cam having an elliptical shape when viewed from a direction of a rotation axis, an elastic tubular member including a plurality of first tooth parts at an outer circumferential surface and being elastically deformable, and an annular member including a plurality of second tooth parts at an inner circumferential surface,
part of the plurality of first tooth parts of the elastic tubular member and part of the plurality of second tooth parts of the annular member are engaged with each other,
the shaft includes a spline shaft part at which a plurality of protrusions are formed in a circumferential direction of an outer circumferential surface,
the wave generating member includes an insertion hole into which the spline shaft part is inserted and that has recesses having a shape corresponding to a shape of the protrusions of the spline shaft part,
the spline shaft part and the insertion hole have a shape in which a gap in a radial direction is present between the spline shaft part and the insertion hole, and
the gap has a size such that a rotation center axis of the wave generating member is always movable and alignment is possible due to elasticity of the elastic tubular member in a direction in which an eccentricity with respect to a center axis of the elastic tubular member is canceled.

2. The power transmission mechanism for a robot of claim 1, comprising a movement restriction part that restricts movement of the wave generating member in two axial directions.

3. The power transmission mechanism for a robot of claim 1, wherein the shaft includes a step part which is in contact with an end face of the wave generating member in an axial direction and at which an outer diameter is changed, and the step part has a shape that restricts movement of the wave generating member in the axial direction.

4. The power transmission mechanism for a robot of claim 1, wherein the shaft is a hollow shaft having a cylindrical shape.

5. The power transmission mechanism for a robot of claim 1, wherein cross-sectional shapes of the protrusions and the recesses are formed by involute curves.

6. A drive device for a robot, comprising:
the power transmission mechanism for a robot of claim 1; and
an electric motor configured to rotate a shaft.
